(19) United States
(12) Patent Application Publication
(10) Pub. No.: US 2025/0026874 A1
(43) Pub. Date: Jan. 23, 2025

(54) MULTI-STAGE COPOLYMERS AS BINDER FOR COATING AGENTS

(71) Applicant: Wacker Chemie AG, Munich (DE)

(72) Inventors: Hans-Peter Weitzel, Munich (DE); Stefan Baueregger, Munich (DE)

(73) Assignee: Wacker Chemie AG, Munich (DE)

(21) Appl. No.: 18/715,177

(22) PCT Filed: Nov. 2, 2022
(86) PCT No.: PCT/EP2022/080481

§ 371 Date: May 31, 2024

(51) Int. Cl. C08F 218/08; C08F 220/14; C08F 220/18; C08F 255/02; C09D 5/02; C09D 131/04; C09D 133/08; C09D 133/12

(52) U.S. Cl. CPC C08F 218/08; C08F 220/14; C08F 220/1804; C08F 255/026; C09D 5/022; C09D 131/04; C09D 133/08; C09D 133/12; C08F 2800/20

(57) ABSTRACT

A process for preparing multistage copolymers in the form of aqueous dispersions by multistage, radically initiated emulsion polymerization includes a first stage, second stage, and third stage. In the first stage, 20% to 75% by weight of vinyl acetate, optionally ethylene and optionally one or more further ethylenically unsaturated monomers are polymerized. In the second stage, in the presence of the polymer from the first stage, 1% to 25% by weight of vinyl acetate, 0.01% to 2% by weight of one or more ethylenically unsaturated silicon-functional monomers and optionally one or more further ethylenically unsaturated monomers are polymerized. In the third stage, in the presence of the polymer from the second stage, 5% to 40% by weight of one or more monomers selected from the group encompassing esters of acrylic acid, esters of methacrylic acid and vinyl aromatics and optionally one or more further ethylenically unsaturated monomers are polymerized.

The invention relates to multistage copolymers of vinyl acetate and (meth)acrylic esters or vinyl aromatics in the form of aqueous dispersions, to processes for preparing them, and to their use for example as binders for aqueous coating materials, especially those with a high pH, such as for emulsion paints or renders, for example.

Conventional aqueous coating materials, such as emulsion paints or dispersion-based renders, with vinyl acetate copolymers as binders are typically protected from bio-contamination by addition of biocides, such as isothiazolinones, as in-can preservatives, so as to prevent the growth of microorganisms and to ensure shelf stability. For some time already, however, such biocides have been under intensified regulatory pressure, and the market is therefore increasingly demanding aqueous coating materials that are preservative-free. In one such approach, the in-can preservation is achieved by adjusting the aqueous coating materials to high pH levels—to PH levels of 10 to 11.5, for example—to prevent the growth of microorganisms, to achieve shelf stability, and so to remove the need for preservatives.

For preservative-free coating materials with high pH levels, examples of common binders include styrene-acrylic copolymers or poly(meth)acrylates. Such copolymers, however, fail to achieve the pigment-binding capacity of vinyl acetate copolymers. However, conventional vinyl acetate copolymers are not stable at pH levels of 10 to 11.5, for example, so ruling out such vinyl acetate copolymers for coating materials with high pH levels. The reason is that binders of this kind based on vinyl acetate undergo hydrolysis in alkaline formulations, thereby lowering the pH of the alkaline coating material, meaning that over the course of time, the coating material is no longer adequately protected from bio-contamination. The need exists, consequently, to provide shelf-stable aqueous coating materials with high pH levels that comprise vinyl acetate copolymers as binders.

Preservative-free emulsion paints with high pH levels and straight acrylic or styrene-acrylic copolymers as binders are widely described. For example, WO 2002000798 describes corresponding emulsion paints with styrene-acrylic dispersions as binders for preservative-free paints of high pH, especially for the interior sector, with waterglass as an additive. The preservative-free, high-pH emulsion paints of US 10988627 and DE 102014013455 contain specifically acrylic or styrene-acrylic copolymers as binders and also, as an additive, alkali metal alkylsiliconate or, generally, siliconates for the purpose of stabilizing the emulsion paints, especially the pH. Further biocide-free, high-pH emulsion paints with (styrene-) acrylic copolymers are disclosed for example in DE 202017106112 and DE 202018101199. EP 3974479 mentions preservative-free coating materials of high pH which comprise hybrid binders composed of silicon dioxide and (meth)acrylate polymers and optionally further polymers. DE 102017008984 as well is concerned with shelf-stable coating materials. US 2021269653 AA describes corresponding emulsion paints comprising emulsion polymers based on ethylhexyl acrylate, butyl acrylate and vinyl aromatics.

US 2021002506 AA describes the preparation of styrene-acrylic copolymers via multistage emulsion polymerization, with all of the polymerization stages using styrene and acrylates as principal monomers, and describes the use of these multistage polymers in biocide-free gloss and semigloss coating compositions which are formulated to a pH of at least 10 using water-soluble alkali metal or alkaline earth metal alkylsiliconate.

Certain texts also disclose high-pH emulsion paints with vinyl acetate copolymers. U.S. Pat. No. 7,789,959, for instance, recommends, as binders for preservative-free emulsion paints or varnishes, copolymers of vinyl esters of short-chain carboxylic acids (C₁-C₄ carbon atoms), vinyl esters of long-chain carboxylic acids (C₅-C₁₈ carbon atoms), and olefins. U.S. Pat. No. 10,899,918 describes water-resistant copolymers comprising a first polymer phase based on vinyl esters, optionally an intermediate polymer phase, and a second polymer phase based on (meth)acrylic esters and/or styrene, with the intermediate polymer phase determining the hydrophilicity or hydrophobicity and the second polymer phase specifically containing acid monomer units.

U.S. Pat. No. 9,902,785, for improving the mechanical or flame retardancy properties and for reducing the soiling propensity or the water absorption of mortars or paint coatings, recommends adding a two-stage copolymer obtainable by copolymerization of vinyl esters and ethylene in the first stage and also (meth)acrylic esters in the second stage; in the first and/or second stages, any desired further monomers may optionally be used, such as, for example, epoxy-, silicon-, carboxylic acid-, sulfonic acid-, phosphonic acid-, hydroxyl- or N-methylol-functional monomers or else polyethylenically unsaturated monomers. U.S. Pat. No. 8,993,668 describes similar in order to equip coatings with improved tensile strength. For reducing the water absorption of paints or mortar, US 2021230315 teaches multistage copolymers having average particle diameters of <200 nm and PH levels of 2.5 to 8, prepared via multistage emulsion polymerization of 1) vinyl acetate and long-chain vinyl esters and 2) (meth)acrylic esters or vinyl aromatics and acid monomers. Acid monomers in the second stage are therefore essential in this context.

Against this background, the object was to provide vinyl acetate copolymers in the form of aqueous dispersions which when used in emulsion paints having pH levels of 10 to 11.5 result in paints having high pH stability and also high pigment-binding capacity and which after application, furthermore, lead to paint coatings having advantageous wet abrasion resistance and high hiding power.

One subject of the invention are processes for preparing multistage copolymers in the form of aqueous dispersions by multistage, radically initiated emulsion polymerization, characterized in that
a) in a first stage, 20% to 75% by weight of vinyl acetate, optionally ethylene and optionally one or more further ethylenically unsaturated monomers are polymerized,
b) in a second stage, in the presence of the polymer from the first stage a), 1% to 25% by weight of vinyl acetate, 0.01% to 2% by weight of one or more ethylenically unsaturated silicon-functional monomers and optionally one or more further ethylenically unsaturated monomers are polymerized, and
c) in a third stage, in the presence of the polymer from the second stage b), 5% to 40% by weight of one or more monomers selected from the group encompassing esters of acrylic acid, esters of methacrylic acid and vinyl aromatics and optionally one or more further ethylenically unsaturated monomers are polymerized, with the proviso that in the third stage c), no ethylenically unsaturated carboxylic acid is polymerized,
   where the figures in % by weight are based on the total weight of the monomers used overall in stages a) to c).

A further subject of the invention are multistage copolymers in the form of aqueous dispersions obtainable by the aforesaid multistage, radically initiated emulsion polymerization process.

In the first stage a), preferably 30% to 65%, particularly preferably 35% to 60% and most preferably 40% to 55% by weight of vinyl acetate are polymerized, based on the total weight of the monomers used overall in stages a) to c).

In the first stage a), preferably ≥40%, particularly preferably 50% to 90% and most preferably 60% to 80% by weight of vinyl acetate are polymerized, based on the total weight of the monomers of stage a).

In the first stage a), preferably 1% to 40%, particularly preferably 2% to 30% and most preferably 5% to 15% by weight of ethylene are polymerized, based on the total weight of the monomers used overall in stages a) to c).

In the first stage a), preferably 1% to 30%, particularly preferably 5% to 25% and most preferably 10% to 20% by weight of ethylene are polymerized, based on the total weight of the monomers of stage a).

Preferred further ethylenically unsaturated monomers for the first stage a) are vinyl esters of unbranched or branched carboxylic acids having 3 to 18 carbon atoms, and ethylenically unsaturated acids.

Preferred for use in the first stage a) as further monomers are one or more vinyl esters of unbranched or branched carboxylic acids having 3 to 18 carbon atoms, and one or more ethylenically unsaturated acids.

Preferred vinyl esters of unbranched or branched carboxylic acids having 3 to 18 carbon atoms are vinyl propionate, vinyl butyrate, vinyl 2-ethylhexanoate, vinyl laurate, 1-methyl-vinyl acetate, vinyl pivalate and vinyl esters of α-branched monocarboxylic acids having 9 to 11 carbon atoms, as for example VeoVa9R or VeoVa10R (trade names of Momentive). Particular preference is given to vinyl versatate and vinyl laurate.

Preferred ethylenically unsaturated acids are ethylenically unsaturated carboxylic acids, ethylenically unsaturated phosphonic and phosphoric acids, and especially ethylenically unsaturated sulfonic acids, and also their salts.

Examples of ethylenically unsaturated sulfonic acids are vinylsulfonic acid, 2-acrylamido-2-methylpropanesulfonic acid, 2-acryloyloxyethansulfonic acid and 2-methacryloyloxyethansulfonic acid, and 2-acryloyloxy- and 3-methacryloyloxypropanesulfonic acid. Preference is given to vinylsulfonic acid and 2-acrylamido-2-methylpropanesulfonic acid.

Examples of ethylenically unsaturated carboxylic acids, such as monocarboxylic or dicarboxylic acids, are acrylic acid, methacrylic acid, crotonic acid, maleic acid, fumaric acid and itaconic acid. Preference is given to acrylic acid, methacrylic acid and fumaric acid.

Examples of ethylenically unsaturated phosphonic acids or phosphoric acids are vinylphosphonic acid, esters of phosphonic acid or phosphoric acid with hydroxyalkyl (meth)acrylates, and ethylenically unsaturated polyethoxyalkyl ether phosphates.

In addition to or instead of the aforesaid acids, their salts may also be used, preferably their alkali metal or ammonium salts, particularly preferably their sodium salts, such as, for example, the sodium salts of vinylsulfonic acid and of 2-acrylamidopropanesulfonic acid.

The further ethylenically unsaturated monomers of the first stage a) are generally different from vinyl acetate and ethylene.

In the first stage a), preferably 0% to 25%, particularly preferably 0.1% to 20% and most preferably 1% to 15% by weight of further ethylenically unsaturated monomers of the first stage a), more particularly vinyl esters of unbranched or branched carboxylic acids having 3 to 18 carbon atoms, are polymerized, based on the total weight of the monomers used overall in stages a) to c).

In the first stage a), preferably 0% to 40%, particularly preferably 0.1% to 30% and most preferably 1% to 20% by weight of further ethylenically unsaturated monomers of the first stage a), more particularly vinyl esters of unbranched or branched carboxylic acids having 3 to 18 carbon atoms, are polymerized, based on the total weight of the monomers of stage a).

In the first stage a), preferably 0% to 2%, particularly preferably 0.01% to 1% and most preferably 0.1% to 0.5% by weight of ethylenically unsaturated acids are polymerized, based on the total weight of the monomers used overall in stages a) to c).

In the first stage a), preferably 0% to 10%, particularly preferably 0.01% to 5% and most preferably 0.1% to 2% by weight of ethylenically unsaturated acids are polymerized, based on the total weight of the monomers of stage a).

In the first stage a) there are preferably no ethylenically unsaturated carboxylic acids copolymerized.

The further ethylenically unsaturated monomers of the first stage a) preferably comprise no ethylenically unsaturated silicon-functional monomers and/or no ethylenically unsaturated epoxy-functional comonomers.

Examples of ethylenically unsaturated epoxy-functional comonomers are glycidyl methacrylate and glycidyl acrylate. Examples of ethylenically unsaturated silicon-functional monomers are stated later on below.

The further ethylenically unsaturated monomers of the first stage a) preferably comprise no esters of acrylic acid or methacrylic acid and no vinyl aromatics. Preferably, in the first stage a), no esters of acrylic acid or methacrylic acid and no vinyl aromatics are copolymerized or used.

In the second stage b), preferably 2% to 20%, particularly preferably 5% to 15%, by weight of vinyl acetate are polymerized, based on the total weight of the monomers used overall in stages a) to c).

In the second stage b), preferably 40% to 99.9%, more preferably 50% to 99%, more preferably still 55% to 95%, particularly preferably 60% to 90%, very particularly preferably 65% to 85% and most preferably 70% to 80% by weight of vinyl acetate are polymerized, based on the total weight of the monomers of stage b).

Alternatively, in the second stage b), preferably 40% to 99.99%, more preferably 80% to 99.9%, particularly preferably 85% to 99.5% and most preferably 90% to 99% by weight of vinyl acetate are polymerized, based on the total weight of the monomers of stage b).

Ethylenically unsaturated silicon-functional monomers of the second stage b) are, for example, ethylenically unsaturated silicon compounds of the general formula R¹SiR²₀₋₂(OR₃)₁₋₃, where R¹ has the meaning CH₂═CR⁴—(CH₂)₀₋₁ or CH₂═CR⁴CO₂ (CH₂)₁₋₃, R² has the meaning C₁ to C₃ alkyl radical, C₁ to C₃ alkoxy radical or halogen, preferably Cl or Br, R³ is an unbranched or branched, optionally substituted alkyl radical having 1 to 12 carbon atoms, preferably 1 to 3 carbon atoms, or is an acyl radical having 2 to 12 carbon atoms, where R³ may optionally be interrupted by an ether group, and R⁴ is H or CH₃.

Preferred ethylenically unsaturated silicon-functional monomers are γ-acryl- and/or γ-methacryloxypropyltri(alkoxy)-silanes, α-methacryloxymethyltri(alkoxy)silanes, γ-methacryloxypropylmethyldi(alkoxy)silanes; vinylsilanes such as vinylalkyldi(alkoxy)silanes and vinyltri(alkoxy)silanes, where examples of alkoxy groups that may be used are methoxy, ethoxy, methoxyethylene, ethoxyethylene, methoxypropylene glycol ether and/or ethoxypropylene glycol ether radicals.

Examples of preferred ethylenically unsaturated silicon-functional monomers are 3-methacryloxypropyltrimethoxysilane, 3-methacryloxypropylmethyldimethoxysilane, vinyltrimethoxysilane, vinylmethyldimethoxysilane, vinyltriethoxysilane, vinylmethyldicth-oxysilane, vinyltripropoxysilane, vinyltriisopropoxysilane, vinyltris(1-meth-oxy) isopropoxysilane, vinyltributoxysilane, vinyltriacetoxysilane, methacryloxymethyltri-methoxysilane, 3-methacryloxypropyltris(2-methoxyethoxy) silane, vinyltrichlorosilane, vinylmethyldichlorosilane, vinyltris(2-methoxyethoxy) silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexoxysilane, vinyltrioctyloxysilane, vinyldimethoxyoctyloxysilane, vinylmethoxydioctyloxysilane, vinylmeth-oxydilauryloxysilane, vinyldimethoxylauryloxysilane and also polyethylene glycol-modified vinylsilanes.

Suitable ethylenically unsaturated silicon-functional monomers of the second stage b) are also (meth)acrylamides containing silane groups, of the general formula CH₂=CR⁵—CO—NR⁶—R⁷—SiR⁸ₙ—(R⁹)₃₋ₘ, where n=0 to 4, m=0 to 2, R⁵ is either H or a methyl group, R⁶ is H or an alkyl group having 1 to 5 carbon atoms, R⁷ is an alkylene group having 1 to 5 carbon atoms or is a divalent organic group in which the carbon chain is interrupted by an O or N atom, R⁸ is an alkyl group having 1 to 5 carbon atoms, and R⁹ is an alkoxy group having 1 to 40 carbon atoms which may be substituted by further heterocycles. In monomers in which there are 2 or more R⁵ or R⁹ groups, these groups may be identical or different.

Examples of such (meth)acrylamido-alkylsilanes are as follows: 3-(meth)acrylamido-propyltrimethoxysilane, 3-(meth)acrylamido-propyltriethoxysilane, 3-(meth)acrylamido-propyltri(β-methoxyethoxy) silane, 2-(meth)acrylamido-2-methylpropyltrimethoxysilane, 2-(meth)acrylamido-2-methylethyltrimethoxysilane, N-(2-(meth)acrylamido-ethyl)aminopropyltrimethoxysilane, 3-(meth)acrylamido-propyltriacetoxysilane, 2-(meth)acrylamido-ethyltrimethoxysilane, 1-(meth)acrylamido-methyltrimethoxysilane, 3-(meth)acrylamido-propylmethyldimethoxysilane, 3-(meth)acrylamido-propyldi-methylmethoxysilane, 3-(N-methyl-(meth)acrylamido)-propyltrimethoxysilane, 3-((meth)acrylamido-methoxy)-3-hydroxypropyltrimethoxysilane, 3-((meth)acrylamido-methoxy)-propyltrimethoxysilane, N,N-dimethyl-N-trimethoxysilylpropyl-3-(meth)acrylamido-propylammonium chloride and N,N-dimethyl-N-trimethoxysilylpropyl-2-(meth)acrylamido-2-methylpropylammonium chloride.

Ethylenically unsaturated silicon-functional monomers are most preferably vinyltrimethoxysilane, vinylmethyldimethoxysilane, vinyltriethoxysilane, vinylmethyldiethoxysilane, vinyltris(1-methoxy) isopropoxysilane, methacryloxypropyltris(2-methoxyethoxy) silane, 3-methacryloxypropyltrimethoxysilane, 3-methacryloxypropyl-methyldimethoxysilane and methacryloxymethyltrimethoxysilane and also mixtures thereof.

In the second stage b), preferably 0.01% to 2%, particularly preferably 0.05% to 1.5% and most preferably 0.1% to 1.0% by weight of ethylenically unsaturated silicon-functional monomers are polymerized, based on the total weight of the monomers used overall in stages a) to c).

In the second stage b), preferably 0.1% to 20%, particularly preferably 0.5% to 15% and most preferably 1% to 10% by weight of ethylenically unsaturated silicon-functional monomers are polymerized, based on the total weight of the monomers of stage b).

As further ethylenically unsaturated monomers for the second stage b), preference is given to one or more vinyl esters of unbranched or branched carboxylic acids having 3 to 18 carbon atoms, one or more ethylenically unsaturated acids and optionally one or more ethylenically unsaturated epoxy-functional comonomers. These monomers may for example adopt the preferred, particularly preferred and exemplary embodiments recited earlier on above.

The further ethylenically unsaturated monomers of the second stage b) are generally different from vinyl acetate and ethylenically unsaturated silicon-functional monomers.

In the second stage b), preferably 0% to 15%, particularly preferably 0.5% to 10% and most preferably 1.0% to 5% by weight of further ethylenically unsaturated monomers of the second stage b) are polymerized, based on the total weight of the monomers used overall in stages a) to c).

In the second stage b), preferably 0% to 30%, particularly preferably 0.1% to 20% and most preferably 1% to 10% by weight of further ethylenically unsaturated monomers of the second stage b) are polymerized, based on the total weight of the monomers of stage b).

In the second stage b), preferably up to 2%, particularly preferably 0.01% to 1.5% and most preferably 0.1% to 1.0% by weight of ethylenically unsaturated epoxy-functional comonomers are polymerized, based on the total weight of the monomers used overall in stages a) to c).

In the second stage b), preferably 0.1% to 20%, particularly preferably 0.5% to 15% and most preferably 1% to 10% by weight of ethylenically unsaturated epoxy-functional comonomers are polymerized, based on the total weight of the monomers of stage b).

With particular preference, in the second stage b), no ethylenically unsaturated acids, more particularly no ethylenically unsaturated carboxylic acids, are used and/or copolymerized.

Most preferably, in the second stage b), none of the above-stated further ethylenically unsaturated monomers are used and/or copolymerized.

Esters of acrylic acid or methacrylic acid which carry no epoxy group, and also vinyl aromatics, are preferably not embraced by the further ethylenically unsaturated monomers of the second stage b). With particular preference, the further ethylenically unsaturated monomers of the second stage b) comprise no esters of acrylic acid or methacrylic acid and no vinyl aromatics. The further ethylenically unsaturated monomers of the second stage b) particularly preferably also comprise no ethylenically unsaturated epoxy-functional comonomers.

Preferably, in the second stage b), no additional ethylene is introduced.

Esters of acrylic acid or methacrylic acid of the third stage c) are, for example, esters of unbranched or branched alcohols having 1 to 15 carbon atoms, such as methyl acrylate, methyl methacrylate, ethyl acrylate, ethyl methacrylate, propyl acrylate, propyl methacrylate, n-butyl acrylate, n-butyl methacrylate and 2-ethylhexyl acrylate.

Particular preference is given to copolymerizing 2-ethylhexyl acrylate and/or n-butyl acrylate and one or more esters of acrylic acid or methacrylic acid selected from the group encompassing methyl methacrylate, tert-butyl methacrylate, tert-butyl acrylate, lauryl acrylate, stearyl acrylate and methyl methacrylate.

Preferred vinyl aromatics are methylstyrene and vinyltoluene and particularly styrene.

Preference is also given to copolymerizing one or more esters of (meth)acrylic acid and one or more vinyl aromatics, particularly styrene.

In the third stage c), preferably 5% to 40%, particularly preferably 10% to 35% and most preferably 20% to 30% by weight of one or more monomers selected from the group encompassing esters of (meth)acrylic acid and vinyl aromatics are polymerized, based on the total weight of the monomers used overall in stages a) to c).

In the third stage c), preferably 70% to 100%, particularly preferably 80% to 100% and most preferably 95% to 100% by weight of one or more monomers selected from the group encompassing esters of (meth)acrylic acid and vinyl aromatics are polymerized, based on the total weight of the monomers of stage c).

As further ethylenically unsaturated monomers for the third stage c), preference is given to one or more ethylenically unsaturated silicon-functional monomers and optionally one or more ethylenically unsaturated epoxy-functional comonomers. These monomers may for example adopt the preferred, particularly preferred and exemplary embodiments recited earlier on above.

The further ethylenically unsaturated monomers of the third stage c) are generally different from vinyl aromatics. The further ethylenically unsaturated monomers of the third stage c) preferably comprise exclusively ethylenically unsaturated epoxy-functional comonomers as esters of acrylic acid or methacrylic acid.

In the third stage c), preferably 0.01% to 2%, particularly preferably 0.05% to 1.5% and most preferably 0.1% to 1.0% by weight of ethylenically unsaturated silicon-functional monomers are polymerized, based on the total weight of the monomers used overall in stages a) to c).

In the third stage c), preferably 0.1% to 20%, particularly preferably 0.5% to 15% and most preferably 1% to 10% by weight of ethylenically unsaturated silicon-functional monomers are polymerized, based on the total weight of the monomers of stage c).

In the third stage c), preferably up to 2%, particularly preferably 0.01% to 1.5% and most preferably 0.1% to 1.0% by weight of ethylenically unsaturated epoxy-functional comonomers are polymerized, based on the total weight of the monomers used overall in stages a) to c).

In the third stage c), preferably 0.1% to 20%, particularly preferably 0.5% to 15% and most preferably 1% to 10% by weight of ethylenically unsaturated epoxy-functional comonomers are polymerized, based on the total weight of the monomers of stage c).

Preferably, in the third stage c), no ethylenically unsaturated acids are used and/or copolymerized.

It is also preferred in the third stage c) not to use and/or copolymerize any vinyl esters of unbranched or branched carboxylic acids having 1 to 18 carbon atoms, more particularly no vinyl acetate.

Preferably, in the third stage c), no additional ethylene is introduced.

Esters of acrylic acid or methacrylic acid which carry no epoxy group, and also vinyl aromatics, are preferably not embraced by the further ethylenically unsaturated monomers of the third stage c). With particular preference, the further ethylenically unsaturated monomers of the third stage c) comprise no esters of acrylic acid or methacrylic acid and no vinyl aromatics.

The preferred embodiments in respect of acid monomers and silicon-functional monomers, respectively, in stages a) to c) allow the object of the invention to be achieved more effectively, including in particular an improvement in the wet abrasion resistance.

Multistage copolymers are based on preferably
40% to 80%, more particularly 50% to 70%, by weight of vinyl acetate,
0.01% to 3%, more particularly 0.1% to 0.5%, by weight of ethylenically unsaturated silicon-functional monomers,
10% to 40%, more particularly 20% to 35%, by weight of monomers selected from the group encompassing esters of (meth)acrylic acid and vinyl aromatics,
optionally 1% to 30%, more particularly 5% to 15%, by weight of ethylene, and
optionally 0% to 25%, more particularly 3% to 20%, by weight of further ethylenically unsaturated monomers,
where the figures in % by weight are based on the total weight of the monomers.

Further ethylenically unsaturated monomers employed in this context are preferably 0% to 20%, more particularly 3% to 15%, by weight of vinyl esters of unbranched or branched carboxylic acids having 3 to 18 carbon atoms and optionally 0% to 5%, more particularly 0.1% to 2%, by weight of ethylenically unsaturated acids, especially ethylenically unsaturated sulfonic acids, or salts thereof, based in each case on the total weight of the monomers.

The multistage copolymers are preferably stabilized with emulsifier and/or protective colloid.

The multistage, radically initiated emulsion polymerization takes place preferably in the presence of one or more emulsifiers and/or one or more protective colloids.

Preference is given to using 15% to 30% by weight of protective colloids, based on the overall amount of protective colloids and emulsifiers.

Preference is given to using 70% to 85% by weight of emulsifiers, based on the overall amount of protective colloids and emulsifiers.

Preference is given to using 40% to 70% by weight of nonionic emulsifiers, based on the overall amount of protective colloids and emulsifiers.

Preference is given to using 15% to 30% by weight of anionic emulsifiers, based on the overall amount of protective colloids and emulsifiers, especially in stages a) to c), preferably in stage a).

Examples of protective colloids are polyvinyl alcohols; polyvinyl acetals; polyvinylpyrrolidones; polysaccharides in water-soluble form such as starches (amylose and amylopectin), celluloses and their carboxymethyl, methyl, hydroxyethyl and hydroxypropyl derivatives, dextrins and cyclodextrins; proteins such as casein or caseinate, soy protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids and their water-soluble copolymers; sulfonated melamine-formaldehydes, sulfonated naphthalene-formaldehydes, styrene-maleic acid copolymers and vinyl ether-maleic acid copolymers.

Preferred are partly or fully hydrolyzed polyvinyl alcohols having a degree of hydrolysis of preferably 80 to 100 mol %. Particularly preferred are partly hydrolyzed polyvinyl alcohols having a degree of hydrolysis of 80 to 95 mol %, more particularly having a Höppler viscosity, in 4% aqueous solution, of 1 to 30 mPas (method according to Höppler at 20° C., DIN 53015). The most preferred are polyvinyl alcohols having a degree of hydrolysis of 85 to 94 mol %, more particularly having a Hoppler viscosity, in 4% aqueous solution, of 3 to 15 mPas (method according to Höppler at 20° C., DIN 53015). The stated protective colloids are accessible via processes known to the skilled person.

Protective colloids can be used in any of stages a) to c), but are preferably used in the first stage a), more particularly in the initial charge thereof. Particular preference is given to using protective colloids exclusively in the first stage a).

Protective colloids are present in an amount of preferably 0.01% to 10%, particularly preferably 0.05% to 5% and most preferably 0.1% to 1.5% by weight, based on the total weight of the monomers used overall in stages a) to c).

In the first stage a), preferably 0.5% to 15%, particularly preferably 0.5% to 10% and most preferably 0.5% to 5% by weight of protective colloids are used, based on the total weight of the monomers of stage a).

Suitable emulsifiers are generally cationic emulsifiers, more particularly nonionic emulsifiers and/or anionic emulsifiers. The multistage, radically initiated emulsion polymerization takes place preferably in the presence of one or more nonionic emulsifiers and one or more anionic emulsifiers.

Examples of anionic emulsifiers are alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl- or alkylarylsulfonates having 8 to 18 carbon atoms, and esters and monoesters of sulfosuccinic acid with monohydric alcohols or alkylphenols. Particularly preferred are alkylsulfonates and alkyl sulfates, especially lauryl sulfates.

Examples of nonionic emulsifiers are those with alkylene oxide groups, more particularly acyl, alkyl, oleyl or alkylaryl ethoxylates, such as alkyl polyglycol ethers or alkylaryl polyglycol ethers having 8 to 40 ethylene oxide units. Preferred are ethoxylated mono-, di- and tri-alkylphenols (preferably with EO degree of 3 to 50 and alkyl substituent radical of C₄ to C₁₂) and ethoxylated fatty alcohols (preferably with EO degree of 3 to 80 and alkyl radical of C₈ to C₃₆), especially C₁₀-C₁₄ fatty alcohol-(3-40)-ethoxylates, polyoxyethylenesorbitan monooleate with 20 ethylene oxide groups, copolymers of ethylene oxide and propylene oxide with a minimum ethylene oxide content of 10 percent by weight, the polyethylene oxide (4-40) ethers of oleyl alcohol and the polyethene oxide (4-40) ethers of nonylphenol. Particularly preferred are the polyethylene oxide (4-40) ethers of fatty alcohols, more particularly of oleyl alcohol, stearyl alcohol or Cu alkyl alcohols.

Emulsifiers can be used in any of stages a) to c), but are preferably used in the first stage a), more particularly in the initial charge thereof. Particular preference is given to using emulsifiers exclusively in the first stage a).

In the first stage a), preferably 0.4% to 15%, particularly preferably 0.8% to 10% and most preferably 1.5% to 5% by weight of emulsifiers are used, based on the total weight of the monomers of stage a).

Emulsifiers are used in an amount of preferably 0.1% to 10%, particularly preferably 0.2% to 7% and most preferably 0.7% to 4% by weight, based on the total weight of the monomers used overall in stages a) to c).

Nonionic emulsifiers are used in an amount of preferably 0.05% to 10%, particularly preferably 0.1% to 5% and most preferably 0.5% to 3% by weight, based on the total weight of the monomers used overall in stages a) to c).

Anionic emulsifiers are used in an amount of preferably 0.05 to 5%, particularly preferably 0.1% to 2% and most preferably 0.2% to 1% by weight, based on the total weight of the monomers used overall in stages a) to c).

With the preferred provisos in relation to protective colloids and emulsifiers, the object of the invention can be achieved even more effectively.

The multistage copolymers are prepared by the emulsion polymerization process.

The temperature for the emulsion polymerization is preferably 40° C. to 120° C., particularly preferably 60° C. to 95° C. When copolymerizing gaseous comonomers such as ethylene, 1,3-butadiene or vinyl chloride, it is also possible to operate under pressure, generally between 5 bar and 100 bar.

Suitable radical initiators are common oil-soluble or water-soluble initiators. Examples of oil-soluble initiators are oil-soluble peroxides, such as t-butyl peroxy-2-ethylhexanoate, t-butyl peroxypivalate, t-butyl peroxyncodecanoate, dibenzoyl peroxide, t-amyl peroxy-pivalate, di(2-ethylhexyl) peroxydicarbonate, 1,1-bis(t-butylperoxy)-3,3,5-trimethyl-cyclohexane, di(4-t-butylcyclohexyl) peroxydicarbonate, dilauroyl peroxide, cumyl hydroperoxide, or oil-soluble azo initiators, such as azobisisobutyronitrile or dimethyl 2,2′-azobis(2-methylpropionate). Examples of water-soluble initiators are peroxodisulfates, such as potassium peroxodisulfate, hydrogen peroxide, water-soluble hydroperoxides such as tert-butyl hydroperoxide, manganese (III) salts or cerium (IV) salts. The initiators are used in general in an amount of 0.005% to 3.0%, preferably 0.01% to 1.5%, by weight, based in each case on the total weight of the ethylenically unsaturated monomers. Using redox initiators is preferred. Redox initiators used comprise combinations of the stated initiators in combination with reducing agents. Examples of suitable reducing agents are sodium sulfite, iron (II) salts, sodium hydroxymethanesulfinate and ascorbic acid. Preferred redox initiators are cerium (IV) salts, such as ammonium cerium (IV) nitrate, manganese (III) salts or peroxodisulfates, and combinations of these initiators. Where reducing agents are used, the amount of reducing agent is preferably 0.01% to 0.5% by weight, based on the total weight of the ethylenically unsaturated monomers.

In the multistage emulsion polymerization of the present process, generally first monomers of stage a), then monomers of stage b) and lastly monomers of stage c) are used/polymerized. Each stage of the multistage polymerization is carried out by means of radical emulsion polymerization.

Stage a) may be carried out with all or some constituents of the reaction mixture included in the initial charge, or with partial initial charging and subsequent metering of all or some constituents of the reaction mixture, or by the metering method without an initial charge. The monomers of stage a) and the initiators in stage a) are entirely or preferably partly included in the initial charge, and any remaining amounts of ethylenically unsaturated monomers and initiators are metered in.

Following the first stage a), the monomers of the second stage b) are added, in the form for example of a solution or an emulsion or, preferably, in pure form. The monomers of the second stage b) are generally added following complete addition of the monomers of the first stage a), and more particularly the monomers of the second stage b) are added immediately following complete addition of the monomers of the first stage a).

The first polymerization stage a) is carried out until preferably at least 70%, particularly preferably at least 80%, by weight of the monomers used in stage a) are polymerized (degree of conversion).

The polymerization is preferably not interrupted after addition of the monomers of the first stage a) and before addition of the monomers of the second stage b).

Alternatively, the polymerization may be interrupted before the monomers of the second stage b) are added, and, on addition of monomers of stage b), initiation may be repeated, by addition of initiator, for example.

The addition of initiator is preferably not interrupted during the transition from the first stage a) to the second stage b).

Initiator for the second stage b) may be added completely at the start of the second stage b), or added partly at the start of the second stage b), with the remainder being metered in over the course of the second stage b), or, preferably, may be metered in completely during the implementation of the second stage b).

The degree of conversion is determined preferably by means of ¹H NMR spectroscopy, more particularly with reference to the polymerized vinyl acetate units and the residual vinyl acetate monomer fraction.

Following the second stage b), the monomers of the third stage c) are added, in the form for example of a solution or an emulsion or, preferably, in pure form. The monomers of the third stage c) are generally added following complete addition of the monomers of the second stage b), and more particularly the monomers of the third stage c) are added immediately following complete addition of the monomers of the second stage b).

The second polymerization stage b) is carried out until preferably at least 85%, particularly preferably at least 90%, by weight of the monomers used in stages a) and b) are polymerized (degree of conversion).

The polymerization is preferably not interrupted after addition of the monomers of the second stage b) and before addition of the monomers of the third stage c).

Alternatively, the polymerization may be interrupted before the monomers of the third stage c) are added, and, on addition of monomers of stage c), initiation may be repeated, by addition of initiator, for example.

The addition of initiator is preferably not interrupted during the transition from the second stage b) to the third stage c).

Initiator for the third stage c) may be added completely at the start of the third stage c), or added partly at the start of the third stage c), with the remainder being metered in over the course of the third stage c), or, preferably, may be metered in completely during the implementation of the third stage c).

Emulsifiers and/or protective colloids, which are also used for stabilization, may be included completely in the initial charge before initiation of the first stage a), or may be partly included in the initial charge, in which case the remainder may be metered in, or they may be metered in completely.

Emulsifiers and/or protective colloids may be introduced generally before and/or during the first stage a) and/or during the second stage b) and/or during the third stage c). Emulsifiers and/or protective colloids are preferably introduced completely before or during the first stage a).

With particular preference, all amounts of emulsifiers and/or protective colloids are included completely in the initial charge before initiation of the first stage a).

After the third stage c), residual monomers may be removed by using known methods of postpolymerization. Volatile residual monomers and other volatile constituents may also be removed by distillation or stripping methods, preferably under reduced pressure.

The aqueous dispersions of the multistage copolymers have a solids content of preferably 30% to 75%, particularly preferably of 45% to 60%, by weight.

The multistage copolymers have weight-average particle diameters Dw of preferably between 200 and 3000 nm, more preferably between 300 and 2500 nm, particularly preferably between 400 and 2000 nm and most preferably between 500 to 1500 nm.

The parameters Dw and Dn/the particle size distribution are determined via laser light diffraction and laser light scattering on the multistage copolymers using the LS13320 instrument with the optical model PVAC.RF780D, including PIDS, from Beckmann-Coulter and observing the protocol of the instrument manufacturer, after adequate dilution of the aqueous polymer dispersions with fully demineralized water.

The multistage copolymers have a polydispersity PD of preferably ≤6, more preferably ≤5, more preferably still ≤4, particularly preferably ≤3.5 and most preferably ≤3.1. The polydispersity PD represents the ratio of weight-average particle diameter Dw to number-average particle diameter Dn: PD=Dw/Dn.

With the parameters Dw and PD of the multistage copolymers, the object of the invention can be achieved even more effectively.

The Brookfield viscosity of the aqueous dispersions of the multistage copolymers is preferably 100 to 6000 mPas, particularly preferably 300 to 4000 mPas and most preferably 500 to 2000 mPas (determined using a Brookfield viscometer at 23° C. and 20 rpm for a solids content of the dispersions of 55%).

The monomer selection, or the selection of the weight fractions of the comonomers, is made here such that the multistage copolymers have a glass transition temperature Tg of −50° C. to +120° C., preferably −35° C. to +45° C. The glass transition temperature Tg of the polymers may be ascertained in a known way via Differential Scanning calorimetry (DSC). The Tg may also be calculated in advance approximately by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n and Tgn is the glass transition temperature in kelvins of the homopolymer of the monomer n. Tg values for homopolymers are listed in the Polymer Handbook, 2nd edition, J. Wiley & Sons, New York (1975).

The multistage copolymers are suitable for example as binders for coating materials, such as emulsion paints or renders, for example, particularly having high pH values of for example 10 to 11.5, generally for the interior and exterior sectors.

The emulsion paints or renders preferably contain no biocides.

Emulsion paints contain for example one or more pigments and/or one or more fillers, one or more multistage copolymers, optionally one or more other organic polymers of ethylenically unsaturated monomers, different from the multistage copolymers, and optionally waterglass, optionally siliconates or silicates, optionally one or more additives, and also water.

Preferred formulas for emulsion paints contain 5% to 75% by weight of pigment and/or filler, more particularly 1% to 35% by weight of pigments and/or 0% to 60% by weight of fillers, 1% to 25%, more particularly 5% to 15%, by weight of multistage copolymers (solid/solid), preferably in the form of aqueous dispersions, optionally 0.1% to 25% by weight of other organic polymers of ethylenically unsaturated monomers (solid/solid), preferably in the form of aqueous dispersions, up to 5%, more particularly 0.1% to 3.5%, by weight of waterglass, up to 5%, more particularly 0.1% to 3.5%, by weight of siliconates, more particularly alkali metal alkylsiliconates, or silicates, more particularly water-soluble alkali metal silicates, up to 10%, more particularly 0.1% to 5%, by weight of additives and water, where the figures in % by weight are based on the dry weight of the emulsion paints and add up to 100% by weight.

The coating materials may be produced in conventional ways in common apparatuses. The common pigments, fillers, siliconates, silicates or additives may be employed. Examples of additives are dispersants, wetting agents, thickeners, stabilizers, defoamers and hydrophobizing agents. Further details of preferred constituents of the coating materials or of their production are found for example in WO 2017/144694.

Surprisingly, in spite of their considerable vinyl acetate fraction, the multistage copolymers of the invention are very stable even in aqueous dispersions or aqueous compositions with high pH levels. Hence the pH of the dispersions remains constant even after prolonged storage, even at pH levels of 10 to 11.5. Preservative-free coating materials are possible advantageously with the multistage copolymers of the invention. Moreover, when the multistage copolymers are used in paints, the pigment-dispersing characteristics are very good and application of the paint results in very good wet abrasion resistance and high hiding power.

The copolymerization, in accordance with the invention, of vinyl esters of unbranched or branched carboxylic acids having 3 to 18 carbon atoms allows the pH stability to be further improved.

The examples which follow serve for further elucidation of the invention, without limiting it:
Emulsifier 1: block copolymer of ethylene oxide and propylene oxide 40/60, 20% in water (Genapol PF40);
Emulsifier 2: isotridecyl ethoxylate with 15 ethylene oxide units, 40% in water (Genapol X150);
Emulsifier 3: secondary alkylsulfonate, 30% in water (Mersolat);
Protective colloid 4: partially hydrolyzed polyvinyl alcohol having a Höppler viscosity of 25 mPas and a hydrolysis number of 140;
TBHP: tert-butyl hydroperoxide;
Brüggolit FF6: mixture of various low-valence sulfur compounds, Brüggemann.

### Example 1

A 5 liter pressure autoclave was charged with 835 g of water, 54 g of the 20% aqueous solution of Emulsifier 1, 94 g of the 40% aqueous solution of Emulsifier 2, 54 g of the 30% aqueous solution of Emulsifier 3, 209 g of a 10% aqueous solution of Protective colloid 4 and 17 g of 25% aqueous sodium vinylsulfonate solution, this initial charge being thoroughly mixed. This mixture was adjusted to a pH of 4.0 with 2 g of formic acid (50%). This mixture was then admixed with 6.5 g of 1% iron ammonium sulfate solution and 214 g of vinyl acetate. The emulsion was stirred at 550 rpm and heated to 70° C., after which ethylene was injected to 27 bar, corresponding to an amount of 130 g.

The polymerization was then commenced by addition of TBHP (10%) at 4.1 g/h and Brüggolit FF6 (5%) at 13.4 g/h. 20 min after the start of reaction, the following feeds were commenced: 1500 g of vinyl acetate in 2.5 h, and a solution of 3.5 g of formic acid in 722 g of water in 3.0 h; the initiator feeds were increased to 8.0 g/h TBHP (10%) and 29 g/h Brüggolit FF6 (5%) and the ethylene pressure was increased to 35 bar, until a total amount of ethylene of 330 g (including the above-stated 130 g of ethylene) had been introduced. After the end of metering of vinyl acetate, a feed of 6.5 g of vinyltriethoxysilane and 191 g of vinyl acetate at 394 g/h was commenced for 30 min.

Then a feed of 324 g of butyl acrylate and 324 g of methyl methacrylate was commenced and metered in over 45 min at 865 g/h. After the end of metering, the initiator rates were increased to 9.6 g/h TBHP (10%) and 35.7 g/h Brüggolit FF6 (5%) and polymerization was continued for 40 min.

The autoclave was thereafter cooled and the reaction mixture was freed from unreacted ethylene by letdown. For the reduction of free monomer, a further 13 g of TBHP (10%) and 47.4 g of Brüggolit FF6 (5%) were metered in over 1 h. To conclude, the dispersions where necessary were diluted with water to a maximum solids content of 54%, filtered through 250 μm and discharged.

### Example 2

The procedure was as in Example 1, with the following changes:
in the initial charge, 27 g of Versatic acid vinyl ester and 187 g of vinyl acetate were used instead of 214 g of vinyl acetate;
instead of 1500 g of vinyl acetate, a mixture of 135 g of Versatic acid vinyl ester and 1365 g of vinyl acetate was metered in over 2.5 h.

### Example 3

The procedure was as in Example 1, with the following changes:
in the initial charge, 27 g of Versatic acid vinyl ester and 186 g of vinyl acetate were used instead of 214 g of vinyl acetate;
instead of 1500 g of vinyl acetate, a mixture of 269 g of Versatic acid vinyl ester and 1225 g of vinyl acetate was metered in over 2.5 h;
the mixture of butyl acrylate and methyl methacrylate consisted of in each case 322 g instead of 324 g.

### Example 4

The procedure was as in Example 1, with the following changes:
in the initial charge, 203 g of vinyl acetate were used and the vinyl acetate feed consisted of 1430 g of vinyl acetate;
the mixture of vinyltriethoxysilane and vinyl acetate consisted of 6.5 g and 310 g respectively;
the mixture of butyl acrylate and methyl methacrylate consisted of in each case 386 g instead of 324 g.

### Example 5

The procedure was as in Example 1, with the following changes:
in the initial charge, 198 g of vinyl acetate were used and the vinyl acetate feed consisted of 1390 g of vinyl acetate;
the mixture of vinyltriethoxysilane and vinyl acetate consisted of 6.0 g and 302 g respectively;
the mixture of butyl acrylate and methyl methacrylate consisted of in each case 450 g instead of 324 g.

### Example 6

The procedure was as in Example 1, with the following changes:
in the initial charge, 25 g of Versatic acid vinyl ester and 172 g of vinyl acetate were used instead of 214 g of vinyl acetate;
instead of 1500 g of vinyl acetate, a mixture of 247 g of Versatic acid vinyl ester and 1128 g of vinyl acetate was metered in over 2.5 h;
the mixture of vinyltriethoxysilane and vinyl acetate consisted of 6.0 g and 300 g respectively;
the mixture of butyl acrylate and methyl methacrylate consisted of in each case 445 g instead of 324 g.

### Comparative Example 7

Commercially available aqueous dispersion of a polyvinyl alcohol- and emulsifier-stabilized vinyl acetate-ethylene copolymer, without VeoVa and acrylate comonomer units.

### Comparative Example 8

As Example 1, with the additional metering in in the last stage of 32.4 g of methacrylic acid together with butyl acrylate and methyl methacrylate.

### Comparative Example 9

Commercially available aqueous styrene-acrylic copolymer dispersion.

### Comparative Example 10

As Example 1, with the difference that stages a) and b) were united into a single stage: metered simultaneously into the initial charge, containing the monomers vinyl acetate, ethylene and sodium vinylsulfonate, were 1691 g of vinyl acetate and 6.5 g of vinyltriethoxysilane, under an ethylene pressure as described for Example 1. Then 324 g of butyl acrylate and 324 g of methyl methacrylate were polymerized, as indicated in Example 1.

### Comparative Example 11

As Example 1, with the difference that in stage b) no vinyltriethoxysilane was used and in stage c) 6.5 g of vinyltriethoxysilane were metered in together with butyl acrylate and methyl methacrylate.

### Example 12

As Example 2, with the difference that in stage c), together with butyl acrylate and methyl methacrylate, 6.5 g of vinyltriethoxysilane were additionally metered in.

### Comparative Example 13

As Example 2, with the difference that the 6.5 g of vinyltriethoxysilane, the 191 g of vinyl acetate, the 324 g of butyl acrylate and the 324 g of methyl methacrylate were metered in simultaneously. Stages b) and c) of Example 2 were therefore united into a single stage in Comparative Example 13.

TABLE 1
Monomer composition of the (Comparative) Examples:

| | Ex.1 | | Ex.2 | | Ex.3 | | Ex.4 | |
|---|---|---|---|---|---|---|---|---|
| Monomer^{a)} | [g] | [%] | [g] | [%] | [g] | [%] | [g] | [%] |
| VAM | 1905 | 67.33 | 1743 | 61.60 | 1602 | 56.84 | 1943 | 64.95 |
| E | 270 | 9.54 | 270 | 9.54 | 270 | 9.58 | 270 | 9.03 |
| Veova10 | 0 | 0.00 | 162 | 5.73 | 296 | 10.50 | 0 | 0.00 |
| Silane | 6.5 | 0.23 | 6.5 | 0.23 | 6.5 | 0.23 | 6.5 | 0.22 |
| BA | 324 | 11.45 | 324 | 11.45 | 322 | 11.42 | 386 | 12.90 |
| MMA | 324 | 11.45 | 324 | 11.45 | 322 | 11.42 | 386 | 12.90 |
| Total | 2829.5 | 100 | 2829.5 | 100 | 2818.5 | 100 | 2991.5 | 100 |
| | Ex.5 | | Ex.6 | | CEx.7 | | CEx.8 | |
| Monomer | [g] | [%] | [g] | [%] | [g] | [%] | [g] | [%] |
| VAM | 1905 | 67.33 | 1600 | 52.67 | 2517 | 89.9 | 1905 | 66.57 |
| E | 270 | 9.54 | 270 | 8.89 | 274 | 9.8 | 270 | 9.44 |
| Veova10 | 0 | 0.00 | 272 | 8.95 | 0 | 0 | 0 | 0.00 |
| Silane | 6.5 | 0.23 | 6 | 0.20 | 8 | 0.3 | 6.5 | 0.23 |
| BA | 324 | 11.45 | 445 | 14.65 | 0 | 0 | 324 | 11.32 |
| MMA | 324 | 11.45 | 445 | 14.65 | 0 | 0 | 324 | 11.32 |
| MAA | 0 | 0 | 0 | 0 | 0 | 0 | 32.4 | 1.13 |
| Total | 3066 | 100 | 3038 | 100 | 2800 | 100 | 2861.5 | 100 |
| | CEx.10 | | CEx.11 | | Ex.12 | | CEx.13 | |
| Monomer | [g] | [%] | [g] | [%] | [g] | [%] | [g] | [%] |
| VAM | 1890 | 61.64 | 1905 | 67.33 | 1743 | 61.5 | 1743 | 61.60 |
| E | 270 | 8.81 | 270 | 9.54 | 270 | 9.52 | 270 | 9.54 |
| Veova10 | 0 | 0.00 | 0 | 0.00 | 162 | 5.71 | 162 | 5.73 |
| Silane | 6 | 0.20 | 6.5 | 0.23 | 13 | 0.46 | 6.5 | 0.23 |
| BA | 450 | 14.68 | 324 | 11.45 | 324 | 11.4 | 324 | 11.45 |
| MMA | 450 | 14.68 | 324 | 11.45 | 324 | 11.4 | 324 | 11.45 |
| MAA | 0 | 0 | | | | | | |
| Total | 2829.5 | 100 | 2829.5 | 100 | 2829.5 | 100 | 2829.5 | 100 |

^{a)}VAM: vinyl acetate; E: ethylene; Veova10: Versatic acid vinyl ester; Silane: vinyltriethoxysilane: BA: butyl acrylate; MMA: methyl methacrylate; MAA: methacrylic acid.

The figures for the monomer compositions in Table I take account of the fact that 20% by weight of the ethylene used in each case was not copolymerized but instead discarded as residual gas.

TABLE 2
Analytical data for the polymer dispersions of the (Comparative) Examples:

| | Ex.1 | Ex.2 | Ex.3 | Ex.4 | Ex.5 | Ex.6 | CEx.7 | CEx.8 |
|---|---|---|---|---|---|---|---|---|
| SC* | 54.0 | 52.3 | 53.6 | 54.0 | 54.0 | 53.9 | 55.5 | 58.2 |
| pH* | 4.2 | 5.2 | 5.1 | 4.8 | 5.7 | 4.8 | 4.2 | 4.55 |
| Viscosity* | 290 | 256 | 770 | 820 | 310 | 596 | 1475 | 2080 |
| Tg* | 1 | −0.5 | −0.2 | 2.9 | 2.8 | −0.2 | 6.5 | 6 |
| Dw* | 983 | 1240 | 845 | 984 | 1214 | 1489 | 604 | 745 |
| Dn* | 452 | 398 | 433 | 497 | 576 | 491 | 380 | 412 |
| Dw/Dn* | 2.4 | 3.1 | 1.95 | 1.98 | 2.1 | 3.03 | 1.59 | 1.81 |

| | CEx.10 | CEx.11 | Ex.12 | CEx.13 |
|---|---|---|---|---|
| SC* | 54.7 | 52.2 | 52.3 | 52.3 |
| pH* | 4.5 | 5.0 | 4.8 | 4.8 |
| Viscosity* | 852 | 996 | 652 | 1290 |
| Tg* | 2.4 | −0.7 | −0.9 | 0.4 |
| Dw* | 1863 | 1451 | 1252 | 2014 |
| Dn* | 431 | 459 | 423 | 432 |
| Dw/Dn* | 4.32 | 3.16 | 2.96 | 4.66 |

*SC: solids content [%]; pH: pH level; viscosity: [mPas]; Tg: glass transition temperature [C]; Dw: weight-average particle diameter [nm]; Dn: number-average particle diameter [nm]; Dw/Dn: polydispersity PD.

### Production of an Emulsion Paint:

A paint matrix was produced conventionally by conventional mixing of the formula indicated below. The pH of the paint matrix was 11.9.

Formula of the paint matrix:
301.5 g water.
   7.6 g dispersant.
   4.4 g defoamer.
   4.3 g thickener.
385.8 g filler (CaCO₃).
129.3 g titanium dioxide,
   2.0 g pH modifier,
   15.0 g alkaline component.

Mixing of the paint matrix with the polymer dispersion of the respective (Comparative) Example in accordance with the details in Table 3 produced matt ready-to-use interior emulsion paints. The solids content of the polymer dispersion of the respective (Comparative) Example was adjusted to 50% beforehand.

TABLE 3
Composition of the emulsion paints:

| | Binder content of emulsion paint | |
|---|---|---|
| | 7% polymer | 14% polymer |
| | dispersion | dispersion |
| Paint matrix [g] | 279 | 258 |
| Polymer dispersion (50%) [g] | 21 | 42 |
| Emulsion paint [g] | 300 | 300 |

### Testing of the Shelf Stability of the Emulsion Paints:

After blending of the paint matrix with the polymer dispersion, the pH of the respective emulsion paint was determined (“pH Start”).

The emulsion paints were subsequently stored in a drying cabinet at a temperature of 50° C. After a storage time of 14 days, the paints were removed from the cabinet, cooled to room temperature and then tested for their pH (“pH 14d/50° C.”).

Critical to the assessment of pH stability is the difference (“Delta pH”) between the pH after production (“pH Start”) and after storage of the emulsion paint (“pH 14d/50° C.”). The results of the testing are summarized in Table 4 below.

TABLE 4
pH Stability of the emulsion paints:

| | Emulsion paint | | | | | |
|---|---|---|---|---|---|---|
| | 7 wt % polymer dispersion | | | 14 wt % polymer dispersion | | |
| Polymer | pH | | | pH | | |
| dispersion | Start* | 14 d/50° C.* | Delta* | Start* | 14 d/50° C.* | Delta* |
| Ex.1 | 11.47 | 10.62 | 0.85 | 11.31 | 10.21 | 1.10 |
| Ex.2 | 11.42 | 10.96 | 0.46 | 11.21 | 10.60 | 0.61 |
| Ex.3 | 11.41 | 10.99 | 0.42 | 11.32 | 10.63 | 0.69 |
| Ex.4 | 11.42 | 11.05 | 0.37 | 11.29 | 10.52 | 0.77 |
| Ex.5 | 11.40 | 10.98 | 0.42 | 11.30 | 10.70 | 0.60 |
| Ex.6 | 11.30 | 11.05 | 0.25 | 11.18 | 10.65 | 0.53 |
| CEx.7 | 11.30 | 9.90 | 1.40 | 11.20 | 9.40 | 1.80 |
| CEx.8 | 11.41 | 11.01 | 0.40 | 11.31 | 10.68 | 0.63 |
| CEx.9 | 11.40 | 10.84 | 0.56 | 11.21 | 10.64 | 0.57 |

*Start: pH level of the emulsion paint after its production;
14 d/50° C.: pH level of the emulsion paint after storage for 14 days at 50° C.;
Delta: Difference in pH levels at “Start” and “14 d/50° C.”.

The emulsion paints with inventive polymer dispersions all had pH levels after storage of above 10. This is the precondition for the production of preservative-free emulsion paints, since under these conditions the growth of microorganisms in the paint is strongly suppressed.

Conversely, in the case of the non-inventive emulsion paint with the VAE polymer dispersion of Comparative Example 7, the pH had dropped below a pH level of 10 after just 2 weeks of storage.

Surprisingly, the pH stability of the inventive emulsion paints, in spite of their vinyl acetate fraction, is comparable with or even better than that of the emulsion paint containing the acrylate polymer dispersion of Comparative Example 9 as binder.

This means that the desired pH stability of vinyl acetate copolymers is achieved as a result of the multistage polymerization of the invention.

### Testing of the Hiding Power of the Emulsion Paints:

The hiding power was ascertained by the method described in “Guidelines for determining the hiding power” from the German Paint Industry Association, July 2002 edition, in accordance with DIN EN 13300.

The respective emulsion paint was applied using an automatic film applicator, with a doctor having a slot height of 150 μm and 225 μm, to respective black-white contrast cards (type 3H from Leneta) with tristimulus value Y over black of 7 or less and tristimulus value Y over white of 80 to 90. The contrast cards coated accordingly were dried for 24 hours at 23° C. and 50% relative humidity and then weighed.

The coverage in m²/l was calculated in each case from the application rate in g/m² and the color density.

Using a colorimeter (Elrepho 450X from Datacolor), the tristimulus values Y (color standards) over the black and the white grounds were measured and the “contrast ratio” in percent was calculated.

The values ascertained accordingly for the contrast ratio were plotted in a diagram against the corresponding coverage (m²/l). Interpolation was used to determine the contrast ratio at 6, 7 and 8 m²/l.

The hiding power of the paints was investigated with the variant of 14% binder usage. The results of the testing are summarized in Table 5.

TABLE 5
Hiding power of the emulsion paints:

| | 6 m²/L | 7 m²/L | 8 m²/L |
|---|---|---|---|
| Ex. 1 | 99.2 | 98.9 | 98.6 |
| Ex. 2 | 99.1 | 98.8 | 98.4 |
| Ex. 3 | 99.1 | 98.7 | 98.3 |
| Ex. 4 | 99.2 | 98.8 | 98.4 |
| Ex. 5 | 99.1 | 98.8 | 98.4 |
| Ex. 6 | 99.2 | 98.9 | 98.6 |
| CEx. 7 | 99.0 | 98.6 | 98.2 |
| CEx. 8 | 99.2 | 98.8 | 98.4 |
| CEx. 9 | 98.6 | 98.0 | 97.4 |

The pigment-binding capacity/hiding power of emulsion paints with vinyl acetate copolymers as binders is known to be greater than for corresponding emulsion paints with acrylate copolymers as binders, as discussed at the outset and shown with Comparative Example 7 (vinyl acetate copolymer) and Comparative Example 9 (acrylate copolymer). Surprisingly, in spite of their acrylate fraction, the emulsion paints with inventive copolymers display better hiding power than the emulsion paint of Comparative Example 7, containing a vinyl acetate copolymer without acrylate fraction as binder.

This means that the hiding power of binders containing acrylate units is boosted by the multistage polymerization of the invention.

As well as the improved hiding power, moreover, the emulsion paints of the invention at the same time, in spite of their vinyl acetate fraction, exhibit the required stability at high pH levels and therefore enable biocide-free emulsion paints.

The inventive binders exhibit a stability of pH in the paint during storage that is comparable with that of the familiar commercial styrene-acrylic dispersions and, at the same time, exhibit improved properties in respect of the hiding power, thereby facilitating more efficient utilization of white or color pigments.

### Testing of the Scrub Resistance SR (Wet Abrasion Resistance) of the Emulsion Paints:

The wet abrasion resistance was determined by the nonwoven-pad method in accordance with ISO 11998. For this purpose, the respective emulsion paint was applied with an applicator in a film thickness of 300 μm (wet) to a Leneta sheet (PVC sheet). The emulsion paints employed were those described above with 14% by weight of polymer dispersion in each case.

This was followed by storage for 72 hours under standard conditions (DIN 50014, 23° C. and 50% relative humidity), then 24 hours at 50° C. and lastly 24 hours under standard conditions. The resulting dry film thickness was 200 μm.

Then three test strips in each case, with dimensions of 2.5 cm×7.5 cm, were cut out and subsequently weighed.

The test strips underwent 200 cycles of scrub testing with the scrubbing pad (3M Scotch-Brite®, Handpad 7448, gray, type S UFN), after which they were weighed again. From the color density of the scuffed area and the loss of mass of the paint film, the paint loss in μm was then calculated.

The lower the paint loss, the higher the wet abrasion resistance.

An average was formed from three measurements in each case.

The results of the testing are summarized in Table 6 below.

It is apparent from Table 6 that the emulsion paints with the polymer dispersions of Example 1 and Example 2, respectively, as binders exhibited considerably higher wet abrasion resistances than the corresponding emulsion paints with the polymer dispersions of Comparative Example 8 (acid copolymerized additionally in stage c)) and, respectively, of Comparative Example 10 (polymerization stages a) and b) combined into one stage), of Comparative Example 11 (silane polymerized in stage c), but not in stage b)) or of Comparative Example 13 (polymerization stages b) and c) combined into one stage). Particularly high wet abrasion resistance was obtained with the polymer dispersion of Example 12 (silane polymerized in stage b) and also in stage c)).

TABLE 6
Wet abrasion resistance of the emulsion paints with the polymer dispersions
from (Comparative) Examples 1, 8 and 10 as binders

| Polymer dispersion | Wet abrasion[μm] |
|---|---|
| Example 1 | 32 |
| Compar. Example 8 | 48 |
| Compar. Example 10 | 36 |
| Compar. Example 11 | 34 |
| Example 2 | 31 |
| Example 12 | 20 |
| Compar. Example 13 | 37 |

1-19. (canceled)

20. A process for preparing multistage copolymers in the form of aqueous dispersions by multistage, radically initiated emulsion polymerization, comprising:
a) in a first stage, 20% to 75% by weight of vinyl acetate, optionally ethylene and optionally one or more further ethylenically unsaturated monomers are polymerized,
b) in a second stage, in the presence of the polymer from the first stage a), 1% to 25% by weight of vinyl acetate, 0.01% to 2% by weight of one or more ethylenically unsaturated silicon-functional monomers and optionally one or more further ethylenically unsaturated monomers are polymerized, and
c) in a third stage, in the presence of the polymer from the second stage b), 5% to 40% by weight of one or more monomers selected from the group encompassing esters of acrylic acid, esters of methacrylic acid and vinyl aromatics and optionally one or more further ethylenically unsaturated monomers are polymerized,
with the proviso that in the third stage c), no ethylenically unsaturated carboxylic acid is polymerized,
where the figures in % by weight are based on the total weight of the monomers used overall in stages a) to c).

21. The process for preparing multistage copolymers in the form of aqueous dispersions as claimed in claim 20, wherein in the first stage a), ≥40% by weight of vinyl acetate are polymerized, based on the total weight of the monomers of stage a).

22. The process for preparing multistage copolymers in the form of aqueous dispersions as claimed in claim 20, wherein in the first stage a), 1% to 40% by weight of ethylene are polymerized, based on the total weight of the monomers used overall in stages a) to c).

23. The process for preparing multistage copolymers in the form of aqueous dispersions as claimed in claim 20, wherein in the first stage a), 1% to 30% by weight of ethylene are polymerized, based on the total weight of the monomers of stage a).

24. The process for preparing multistage copolymers in the form of aqueous dispersions as claimed in claim 20, wherein in the first stage a), 0.1% to 25% by weight of vinyl esters of unbranched or branched carboxylic acids having 3 to 18 carbon atoms are polymerized, based on the total weight of the monomers used overall in stages a) to c).

25. The process for preparing multistage copolymers in the form of aqueous dispersions as claimed in claim 20, wherein in the first stage a), 0.01% to 2% by weight of ethylenically unsaturated acids are polymerized, based on the total weight of the monomers used overall in stages a) to c).

26. The process for preparing multistage copolymers in the form of aqueous dispersions as claimed in claim 20, wherein in the first stage a), no esters of acrylic acid, no esters of methacrylic acid and no vinyl aromatics are copolymerized.

27. The process for preparing multistage copolymers in the form of aqueous dispersions as claimed in claim 20, characterized in that in the second stage b), 40% to 99.9% by weight of vinyl acetate are polymerized, based on the total weight of the monomers of stage b).

28. The process for preparing multistage copolymers in the form of aqueous dispersions as claimed in claim 20, characterized in that one or more ethylenically unsaturated silicon-functional monomers of the second stage b) are silicon compounds of the general formula R¹SiR²₀₋₂(OR₃)₁₋₃, where R¹ has the meaning CH₂=CR⁴—(CH₂)₀₋₁ or CH₂=CR⁴CO₂ (CH₂)₁₋₃, R² has the meaning C₁ to C₃ alkyl radical, C₁ to C₃ alkoxy radical or halogen, R³ is an unbranched or branched, optionally substituted alkyl radical having 1 to 12 carbon atoms or an acyl radical having 2 to 12 carbon atoms, where R³ may optionally be interrupted by an ether group, and R⁴ is H or CH₃; and/or
one or more ethylenically unsaturated silicon-functional monomers of the second stage b) are (meth)acrylamides of the general formula CH₂=CR⁵—CO—NR⁶—R⁷—SiR⁸ₙ—(R⁹)₃₋ₘ, where n=0 to 4, m=0 to 2, R⁵ is either H or a methyl group, R⁶ is H or an alkyl group having 1 to 5 carbon atoms, R⁷ is an alkylene group having 1 to 5 carbon atoms or is a divalent organic group in which the carbon chain is interrupted by an O or N atom, R⁸ is an alkyl group having 1 to 5 carbon atoms, and R⁹ is an alkoxy group having 1 to 40 carbon atoms which may be substituted by further heterocycles.

29. The process for preparing multistage copolymers in the form of aqueous dispersions as claimed in claim 20, wherein in the second stage b), 0.1% to 20% by weight of ethylenically unsaturated silicon-functional monomers are polymerized, based on the total weight of the monomers of stage b).

30. The process for preparing multistage copolymers in the form of aqueous dispersions as claimed in claim 20, wherein in the second stage b), no ethylenically unsaturated acids, no esters of acrylic acid, no esters of methacrylic acid and no vinyl aromatics are copolymerized.

31. The process for preparing multistage copolymers in the form of aqueous dispersions as claimed in claim 20, characterized in that in the third stage c), 70% to 100% by weight of one or more monomers selected from the group encompassing esters of (meth)acrylic acid and vinyl aromatics are polymerized, based on the total weight of the monomers of stage c).

32. The process for preparing multistage copolymers in the form of aqueous dispersions as claimed in claim 20, wherein in the third stage c), 0.01% to 2% by weight of ethylenically unsaturated silicon-functional monomers are polymerized, based on the total weight of the monomers used overall in stages a) to c).

33. A multistage copolymer in the form of an aqueous dispersion obtainable by the multistage, radically initiated emulsion polymerization process of claim 20.

34. The multistage copolymer in the form of an aqueous dispersion as claimed in claim 33, characterized in that the multistage copolymer is stabilized by one or more protective colloids, one or more nonionic emulsifiers and one or more anionic emulsifiers.

35. The multistage copolymer in the form of an aqueous dispersion as claimed in claim 33, wherein the multistage copolymer has a weight-average particle diameter Dw of between 200 and 3000 nm.

36. The multistage copolymer in the form of an aqueous dispersion as claimed in claim 33, wherein the multistage copolymer has a polydispersity PD of ≤3.5.

37. The use of the multistage copolymer in the form of an aqueous dispersion from claim 33 as a binder for coating materials, such as emulsion paints or renders.

38. The use of the multistage copolymer in the form of an aqueous dispersion from claim 33 as a binder for emulsion paints or renders with pH levels of 10 to 11.5.
